(19) United States
(12) Patent Application Publication
(10) Pub. No.: US 2026/0064811 A1
(43) Pub. Date: Mar. 5, 2026

(54) CLASSIFICATION APPARATUS, CLASSIFICATION METHOD, AND CLASSIFICATION PROGRAM

(71) Applicant: JVCKENWOOD Corporation, Yokohama-shi (JP)

(72) Inventor: Yincheng YANG, Yokohama-shi (JP)

(21) Appl. No.: 19/314,482

(22) Filed: Aug. 29, 2025

(30) Foreign Application Priority Data
Sep. 2, 2024 (JP) 2024-150667

(51) Int. Cl. G06F 18/241; G06N 3/082

(52) U.S. Cl. CPC G06F 18/241; G06N 3/082

(57) ABSTRACT

A classification apparatus includes: a feature extraction unit subjected to training, which includes removing or adding a path across nodes between adjacent layers in a neural network, and adapted to extract a feature quantity of input data; and a classification unit that retains a classification weight of each class and classifies the input data based on the feature quantity and the classification weight in response to the feature quantity as an input. Learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

### BACKGROUND

### 1. Technical Field

The present disclosure relates to a machine learning technology.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-learn CNN parameters in response to the entirety of the dataset. In CNN, the precision estimation for old tasks will be decreased as new tasks are learned. Thus, catastrophic forgetting cannot be avoided in CNN. Namely, the result of learning old tasks is forgotten as new tasks are being learned in continual learning.

NISPA (Neuro-Inspired Stability-Plasticity Adaptation) is proposed as one of non-conventional schemes for learning in a neural network (see, for example, Non-Patent Literature 1). NISPA is a scheme of emulating the memory mechanism of the human brain and removing or adding a path across nodes between adjacent layers during learning. In NISPA, paths across nodes proven to have a high activation during learning (stable nodes) are added, and paths across nodes having a low activation (plastic nodes) are added in a smaller proportion than stable nodes. With this, NISPA can maintain knowledge obtained in the past learning session and can also acquire new knowledge.
[Non-Patent Literature 1] Mustafa Burak Gurbuz & Constantine Dovrolis (2022). NISPA: Neuro-Inspired Stability-Plasticity Adaptation for Continual Learning in Sparse Networks. International Conference on Machine Learning 2022. arXiv: 2206.09117.
[Non-Patent Literature 2] Jason Yosinski, Jeff Clune, Yoshua Bengio & Hod Lipson (2014). How transferable are features in deep neural networks?. Advances in Neural Information Processing Systems 27. arXiv: 1411.1792.

In NISPA, it is described that the density of paths in a connected state (connection density) is kept constant without distinguishing between layers from the input layer to the output layer. Meanwhile, Non-Patent Literature 2 reports that the estimation accuracy could be significantly reduced when disconnection is performed between certain layers (e.g., between the third layer and the fourth layer and between the fourth layer and the fifth layer) than when disconnection is performed between other layers. It is considered that coadaptation to the previous task and the new task is taking place between these certain layers.

### SUMMARY

A classification apparatus according to an embodiment of the present disclosure includes: a feature extraction unit subjected to training, which includes removing or adding a path across nodes between adjacent layers in a neural network, and adapted to extract a feature quantity of input data; and a classification unit that retains a classification weight of each class and classifies the input data based on the feature quantity and the classification weight in response to the feature quantity as an input, wherein learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

Another embodiment of the present disclosure relates to a classification method. The method includes: performing learning, which includes removing or adding a path across nodes between adjacent layers in a neural network, extracting a feature quantity of input data; and retaining a classification weight of each class and classifying the input data based on the feature quantity and the classification weight in response to the feature quantity as an input, wherein the performing of learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

Optional combinations of the aforementioned constituting elements, and implementations of the invention in the form of methods, apparatuses, systems, recording mediums, and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a functional block diagram schematically showing an outline configuration of a classification apparatus according to the embodiment;

FIG. 2 is a functional block diagram schematically showing the machine learning apparatus that trains the feature extraction unit shown in FIG. 1;

FIG. 3 is a flowchart illustrating an example of steps of a learning process performed by the machine learning apparatus shown in FIG. 2;

FIG. 4A shows an example of the initialization process in learning according to NISPA, and FIG. 4B shows an example of the initializing process in learning according to the embodiment; and

FIG. 5A shows an example of the connection adjustment process in learning according to NISPA, and FIG. 5B shows an example of the connection adjustment process in learning according to the embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration.

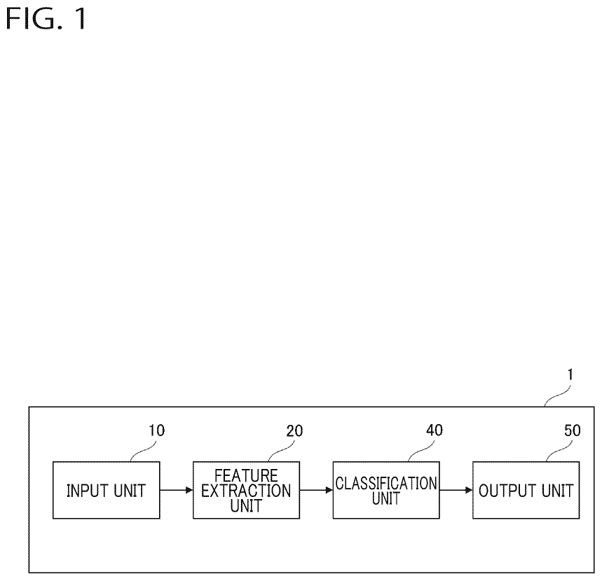

FIG. 1 is a functional block diagram schematically showing an outline configuration of a classification apparatus 1 according to the embodiment. As shown in FIG. 1, the classification apparatus 1 includes an input unit 10, a feature extraction unit 20, a classification unit 40, and an output unit 50.

The input unit 10 receives input data subject to classification by the classification apparatus 1. The input data is, for example, data for an image in which an object is captured, and the captured object is an animal, a vehicle, a person, etc.

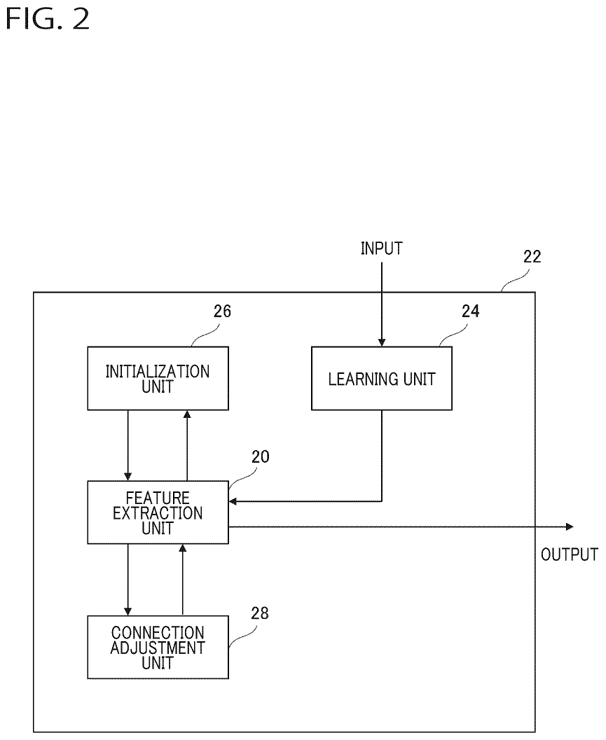

The feature extraction unit 20 extracts the feature quantity of the input data received by the input unit 10. The feature extraction unit 20 is a trained neural network model. The feature extraction unit 20 is subjected to training in advance, which includes removing or adding a path across nodes between adjacent layers in a neural network. The feature extraction unit 20 is trained by a machine learning apparatus 22 (see FIG. 2) described later. The feature extraction unit 20 may be completely trained or may be updatable by being trained further. The number of layers in the neural network model included in the feature extraction unit 20 is seven by way of one example but is not particularly limited as long as there are four layers or more.

The classification unit 40 classifies the input data received by the input unit 10. The classification unit 40 retains the classification weight of each class. The classification unit 40 classifies the input data based on the feature quantity and the classification weight in response to the input data and the feature quantity output by the feature extraction unit 20 as inputs. The classification weight retained by the classification unit 40 is, for example, a feature quantity (centroid) obtained by averaging, per each class, the feature quantity output by the feature extraction unit 20 by using big data. The classification unit 40 compares the feature quantity with the classification weight and defines the class with the closest classification weight to be the classification result.

The output unit 50 outputs the result of classification by the classification unit 40. In other words, the output unit 50 outputs information indicating which class the input data is classified into.

FIG. 2 is a functional block diagram schematically showing the machine learning apparatus 22 that trains the feature extraction unit 20. As shown in FIG. 2, the machine learning apparatus 22 includes the feature extraction unit 20, a learning unit 24, an initialization unit 26, and a connection adjustment unit 28.

The learning unit 24 receives an input of a dataset for each class and trains the feature extraction unit 20 by using the dataset. Each class is learned in one or a plurality of learning phases, and a dataset for each learning phase is used. Each dataset contains a large number of samples. An example of a sample is an image but is not limited thereto. In the case that the sample is an image, a given class relates to, for example, classification into an image of a dog and an image of a cat, and another class relates to classification into an image of a bird and an image of a rabbit. After the learning unit 24 causes the feature extraction unit 20 to learn a given class, the learning unit 24 causes the feature extraction unit 20 to learn a further class.

The initialization unit 26 initializes the path across nodes in the feature extraction unit 20 before the feature extraction unit 20 learns a novel class. In other words, the initialization unit 26 removes or adds the path between nodes. Details of initialization will be described later.

While the feature extraction unit 20 is learning a given class, the connection adjustment unit 28 adjusts the connection state between nodes in the feature extraction unit 20, i.e., removes or adds the path, at a point of time when a certain learning phase is completed. Details of connection adjustment will be described later.

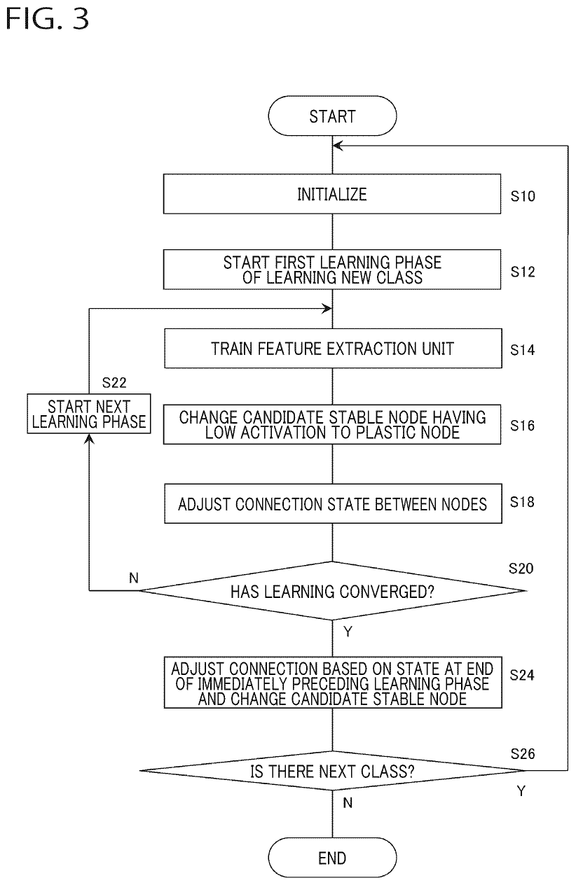

FIG. 3 is a flowchart illustrating an example of steps of a learning process performed by the machine learning apparatus 22. The learning process in the embodiment is an improved version of the scheme according to NISPA. Those aspects that are particularly different from the scheme according to NISPA will be indicated as such in the following.

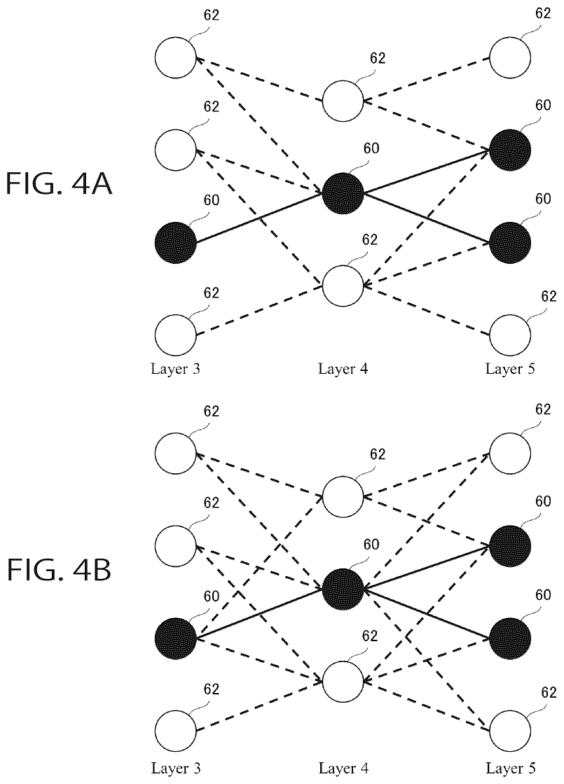

First, before starting to learn a novel class, the initialization unit 26 initializes, among the nodes included in the respective layers in the feature extraction unit 20, the connection state between nodes across adjacent layers (S10). FIG. 4A shows an example of the initialization process in learning according to NISPA, and FIG. 4B shows an example of the initializing process in learning according to the embodiment, i.e., the process of step S10. Specifically, FIGS. 4A and 4B show a state in which the initialization process by the initialization unit 26 is executed after a given class is learned and before the next class starts to be learned. FIGS. 4A and 4B schematically show nodes in the third to fifth layers in the feature extraction unit 20 and their connection state.

Features common to FIGS. 4A and 4B will be described. The nodes are classified into stable nodes 60 and plastic nodes 62. Details of classification into the stable node 60 and the plastic node 62 will be described later, but the nodes are classified based on the activation of the node. The activation of a given node is determined based on the activation of the parent node connected in the layer immediately preceding the node, i.e., the layer toward the input layer, and on the weight of connection with that parent node. Referring to the paths across nodes between adjacent layers, the solid line indicates a path that was already connected before the current initialization process, and the dashed line indicates a path that is newly connected in the current initialization process.

In initialization according to NISPA, paths other than the path connecting the stable nodes 60 and the path connecting the stable node 60 and the plastic node 62 in the layer next to the stable node 60 (the rightward layer in FIG. 4), among the paths connecting nodes between adjacent layers, are randomly established, as shown in FIG. 4A. In other words, in initialization according to NISPA, the path between the stable nodes 60 remains connected, and the path between the stable node 60 and the plastic node 62 in the layer next to the stable node 60 remains removed. The path between the plastic node 62 and the stable node 60 in the layer next to the plastic node 62 and the path between the plastic nodes 62 are randomly established. In this process, NISPA removes or adds the path between nodes to maintain the connection density that occurred before the immediately preceding class learning started. FIG. 4A shows the third to fifth layers, but all other layers are processed in the same way in NISPA.

The difference of the embodiment from NISPA will be described. In the case that the stable node 60 is present in a given layer and the plastic node 62 is present in the next layer (the layer toward the output layer) from the first predetermined layer (the third layer in the illustration; simply referred to as the predetermined layer) to the second predetermined layer (the fifth layer in the illustration) in the feature extraction unit 20, the initialization unit 26 connects the path between that stable node 60 and that plastic node 62, as shown in FIG. 4B. The layers from the first predetermined layer to the second predetermined layer are layers close to the input layer next to the low-order layers from the input layer to the first predetermined layer. It is considered that information common to the input data and not dependent on the class to be learned is transmitted in these layers. Thus, the feature extraction unit 20 maintains the path from the stable node 60 to the plastic node 62 between the first predetermined layer and the second predetermined layer according to the above configuration. It is therefore possible to cause a larger number of paths likely to transmit information when a new task is learned to remain than in NISPA, while utilizing the information on the memory path obtained when a task is learned previously.

All nodes between adjacent layers are connected to each other in the input layer of the feature extraction unit 20, i.e., between the first layer and the first predetermined layer, although the feature is not shown in FIG. 4B. This connection may remain unchanged in the process described later. That all nodes between adjacent layers are connected means that a given node has paths that lead to all nodes in the adjacent layer. The low-order layers from the input layer to the first predetermined layer are considered to be layers that transmit basic information on the input data not dependent on the class to be learned (e.g., information such as the outline and color in the image data). Therefore, the classification performance can be improved by configuring the feature extraction unit 20 as described above.

The initialization unit 26 may perform the same process as that of NISPA in the layers in the feature extraction unit 20 following the second predetermined layer, i.e., the layers toward the output layer. This may also be the case in the process described later. Further, in the process of step S10, the initialization unit 26 may configure all nodes in the feature extraction unit 20 to be plastic nodes in the case that a class is not learned previously and is learned for the first time currently.

Reference is made back to the illustration in FIG. 3. The learning unit 24 starts the first phase of learning a new task (S12). In this process, the learning unit 24 changes all plastic nodes in the feature extraction unit 20 to candidate stable nodes. The learning unit 24 receives a dataset for the current learning phase as an input and trains the feature extraction unit 20 by using the dataset (S14). The feature extraction unit 20 is trained to update the activation of the nodes included in the respective layers.

Subsequently, the learning unit 24 changes the candidate stable node in the feature extraction unit 20 having a low activation to a plastic node (S16). Specifically, the learning unit 24 sorts the candidate stable nodes of the respective layers in the feature extraction unit 20 in the descending order of activation, retains candidate stable nodes included in a predetermined proportion as candidate stable nodes, and changes the candidate stable nodes not included in the predetermined proportion to plastic nodes.

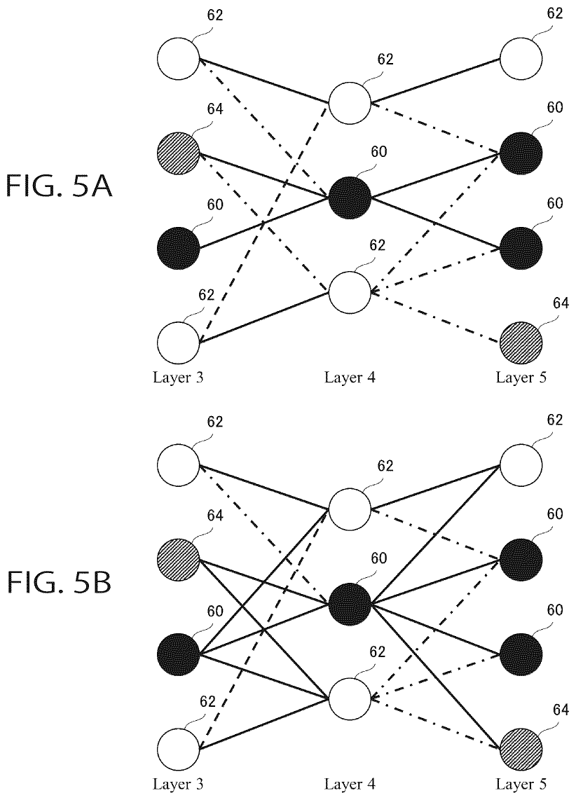

The connection adjustment unit 28 adjusts the connection state between the nodes in the feature extraction unit 20 (S18). FIG. 5A shows an example of the connection adjustment process in learning according to NISPA, and FIG. 5B shows an example of the connection adjustment process in learning according to the embodiment. Specifically, FIGS. 5A and 5B schematically show the nodes in the third to fifth layers in the feature extraction unit 20 and their connection state occurring when a given learning phase to learn a given class is completed. Referring to the paths across nodes between adjacent layers in FIGS. 5A and 5B, the solid line indicates a path that was already connected before the current learning phase, the dashed line indicates a path that is newly connected in the current process, and the dashed-dotted line indicates a path that is newly removed in the current process.

As shown in FIG. 5A, all paths from the plastic node 62 to the stable node 60, the plastic node 62, and the candidate stable node 64 in the next layer are randomly removed in NISPA. Thereafter, the path from the plastic node 62 to the plastic node 62 in the next layer and the path from the plastic node 62 to the candidate stable node 64 in the next layer are randomly connected. However, the path that was connected at the time of initialization is not reconnected. Further, the path from the plastic node 62 to the stable node 60 in the next layer is not reconnected.

The path from the candidate stable node 64 to the stable node 60 in the next layer and the path from the candidate stable node 64 to the candidate stable node 64 in the next layer are connected. Meanwhile, the path from the candidate stable node 64 to the plastic node 62 is randomly disconnected. Thereafter, the path from the candidate stable node 64 to the plastic node 62 is randomly connected. However, the path that was connected at the time of initialization is not reconnected.

In NISPA, all paths from the stable node 60 to the stable node 60, the plastic node 62, and the candidate stable node 64 in the next layer maintain the immediately preceding connection state. In other words, a connected state is maintained in a part where there is a path, and a non-connected state is maintained in a part where there is no path.

The example shown in FIG. 5B shows the feature extraction unit 20 of the embodiment. The connection adjustment unit 28 removes and adds the path in the same manner as in NISPA from the first predetermined layer to the second predetermined layer in the feature extraction unit 20 except for those details described below. The connection adjustment unit 28 of the embodiment connects all of the paths from the stable node 60 to the plastic node 62 in the next layer and the paths from the stable node 60 to the candidate stable node 64 in the next layer from the first predetermined layer to the second predetermined layer in the feature extraction unit 20.

Further, the connection adjustment unit 28 randomly disconnects the path from the candidate stable node 64 to the plastic node 62. The connection adjustment unit 28 randomly reconnects the path from the candidate stable node 64 to the plastic node 62 but, in this process, does not reconnect the path connected at the time of initialization. Connection of the path from the candidate stable node 64 to the plastic node 62 in the next layer is random, but the connection density is configured to be at least higher than in NISPA.

This allows the connection adjustment unit 28 of the embodiment to cause a larger number of paths between layers to remain than in the connection adjustment process according to NISPA and so can improve the classification performance.

Reference is made back to the illustration in FIG. 3. The learning unit 24 determines whether learning has converged (S20). In other words, it is determined whether the classification accuracy is higher after the end of the immediately preceding learning phase than after the end of the current learning phase. When the learning unit 24 determines that learning has not converged (N in S20), the learning unit 24 starts the next learning phase (S22) and returns to the process of step S14. In other words, the machine learning apparatus 22 repeats the process of steps S14 to S18 for a new learning phase until the classification accuracy of the feature extraction unit 20 that has completed the current learning phase is lower than that of the feature extraction unit 20 that has completed the immediately preceding learning phase.

When the learning unit 24 determines that learning has converged (Y in S20), the learning unit 24 proceeds to the process of step S24. In other words, learning in the current learning phase will be overfitting it the case that learning is found to converge. Therefore, the machine learning apparatus 22 does not perform further learning and uses the feature extraction unit 20 that has completed the immediately preceding learning phase.

The learning unit 24 changes the candidate stable node 64 to the stable node 60 or the plastic node 62 based on the state at the end of the immediately preceding learning phase (S24). For example, the learning unit 24 may, throughout each learning phase, change all candidate stable nodes 64 that have not been changed to the plastic node 62 by the process of step S18 to the stable node 60. The connection adjustment unit 28 removes the path of the node changed to the plastic node 62 (S24). In other words, the machine learning apparatus 22 may, of the paths between layers from the first predetermined layer to the last layer (output layer), remove all paths other than those connecting stable nodes.

If there is the next class (Y in S26), the machine learning apparatus 22 returns to the process of step S10. If there is no next class (N of S26), the machine learning apparatus 22 terminates the process.

As described above, the classification apparatus 1 according to the embodiment includes: a feature extraction unit 20 subjected to training, which includes removing or adding a path across nodes between adjacent layers in a neural network, and adapted to extract a feature quantity of input data; and a classification unit 40 that retains a classification weight of each class and classifies the input data based on the feature quantity and the classification weight in response to the feature quantity as an input. Learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

This allows the classification apparatus 1 to maintain the path from the stable node to the plastic node between the predetermined layers. It is therefore possible to cause a larger number of paths likely to transmit information when a new task is learned to remain than in NISPA, while utilizing the information on the memory path obtained when a task is learned previously. Therefore, the classification apparatus 1 can improve the classification performance for the previous task and the new task.

Further, the classification apparatus 1 according to the embodiment may change the plastic node during learning to a candidate stable node different from the stable node or the plastic node. In the case that the stable node is present in the predetermined layer and the candidate stable node is present in the layer next to the predetermined layer, learning may include connecting the stable node and the candidate stable node. This improves the classification performance of the classification apparatus 1 because there are a larger number of paths between layers and a larger quantity of information between layers is transmitted than in NISPA.

Further, the feature extraction unit of the classification apparatus 1 according to the embodiment may connect all nodes between adjacent layers between the input layer and the predetermined layer. The low-order layers from the input layer to the predetermined layer are considered to be layers that transmit basic information on the input data not dependent on the class to be learned (e.g., information such as the outline and color in the image data). Therefore, the classification performance can be improved by implementing above-described configuration.

The above-described various processes in the classification apparatus 1 and the machine learning apparatus 22 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Given above is a description of the present disclosure based on the embodiment. The embodiment is intended to be illustrative only and it will be understood by those skilled in the art that various modifications to combinations of constituting elements and processes are possible and that such modifications are also within the scope of the present disclosure.

What is claimed is:

1. A classification apparatus comprising:
a feature extraction unit subjected to training, which includes removing or adding a path across nodes between adjacent layers in a neural network, and adapted to extract a feature quantity of input data; and
a classification unit that retains a classification weight of each class and classifies the input data based on the feature quantity and the classification weight in response to the feature quantity as an input,
wherein learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

2. The classification apparatus according to claim 1,
wherein the plastic node is changed, during learning, to a candidate stable node different from the stable node or the plastic node,
wherein, in the case that the stable node is present in the predetermined layer and the candidate stable node is present in a layer next to the predetermined layer, learning includes connecting the stable node and the candidate stable node.

3. The classification apparatus according to claim 1,
wherein the feature extraction unit connects all nodes between adjacent layers between the input layer and the predetermined layer.

4. A classification method comprising:
performing learning, which includes removing or adding a path across nodes between adjacent layers in a neural network;
extracting a feature quantity of input data; and
retaining a classification weight of each class and classifying the input data based on the feature quantity and the classification weight in response to the feature quantity as an input,
wherein the performing of learning includes classifying a plurality of nodes in the neural network into a stable node and a plastic node having a lower activation than the stable node and connecting the stable node and the plastic node in the case that the stable node is present in a predetermined layer in the neural network and the plastic node is present in a layer next to the predetermined layer.

5. A classification program comprising computer-implemented modules including:
a module that performs learning, which includes removing or adding a path across nodes between adjacent layers in a neural network;
a module that extracts a feature quantity of input data; and
a module that retains a classification weight of each class and classifies the input data based on the feature quantity and the classification weight in response to the feature quantity as an input,
wherein the module that performs learning includes a module that classifies a plurality of nodes in the neural network into a stable node and a plastic node having a lower activation than the stable node, and a module that connects the stable node and the plastic node in the case that the stable node is present in a predetermined layer in the neural network and the plastic node is present in a layer next to the predetermined layer.
